(19) United States
(12) Patent Application Publication
(10) Pub. No.: US 2026/0299854 A1
(43) Pub. Date: Oct. 1, 2026

(54) INFORMATION PROCESSING DEVICE, PRINT SETTING PRESENTATION METHOD, AND NON-TRANSITORY COMPUTER-READABLE STORAGE MEDIUM STORING PROGRAM

(71) Applicant: SEIKO EPSON CORPORATION, TOKYO (JP)

(72) Inventors: Naoki HAGIHARA, SHIOJIRI-SHI (JP); Ryoki WATANABE, MATSUMOTO-SHI (JP); Hikaru KURASAWA, MATSUMOTO-SHI (JP); Oshi IWAKAMI, CHINO-SHI (JP); Yusuke YAMAZAKI, SHIOJIRI-SHI (JP)

(21) Appl. No.: 19/629,564

(22) Filed: Mar. 26, 2026

(30) Foreign Application Priority Data
Mar. 27, 2025 (JP) 2025-052873

(51) Int. Cl. G06F 3/12

(52) U.S. Cl. CPC G06F 3/1257; G06F 3/1205

(57) ABSTRACT

An information processing device includes: a registration data storage unit that stores registration data in which an embedding that represents a surface characteristic of a fabric and is a vector determined based on a fabric image and a fabric type are associated with each other; a print setting data storage unit that stores print setting data in which the fabric type and a print setting in a printing device are associated with each other; a fabric type specifying unit that collates a target embedding based on a target fabric image with a registered embedding included in the registration data, and thus specifies a fabric type that is the same as or similar to the target fabric; and a presentation unit that presents the print setting associated with the same or similar fabric type specified for the target fabric in the print setting data.

### CROSS-REFERENCE TO RELATED APPLICATION

The present application is based on, and claims priority from JP Application Serial Number 2025-052873, filed Mar. 27, 2025, the disclosure of which is hereby incorporated by reference herein in its entirety.

### BACKGROUND

### 1. Technical Field

The present disclosure relates to an information processing device, a print setting presentation method, and a non-transitory computer-readable storage medium storing a program.

### 2. Related Art

In the technique described in JP-A-2020-30594, a feature of data printed in the past and a print setting in a printing device are registered in association with each other in advance, and at the time of execution of printing, a print setting associated with a feature of data to be printed and a similar feature is recommended.

JP-A-2020-30594 is an example of the related art.

A textile printing machine that prints an ink on a fabric is known. In textile printing, even when the same image is printed, a print setting such as the amount of ink ejection may need to be changed according to the type of fabric of the print medium. When a fabric is used as the print medium, as compared with a print medium formed of paper, the cost tends to increase as the number of times of redoing printing increases. Therefore, a technique that allows a user to easily select an appropriate print setting according to the type of fabric is demanded.

### SUMMARY

The present disclosure can be implemented according to the aspects given below.

According to a first aspect of the present disclosure, an information processing device that presents a print setting in a printing device using a fabric as a print medium is provided. The information processing device includes: a registration data storage unit that stores, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other; a print setting data storage unit that stores, for each of a plurality of fabric types, print setting data in which the fabric type and a print setting in the printing device are associated with each other; a fabric type specifying unit that collates a target embedding that is the embedding based on a target fabric image acquired by picking up an image of a target fabric with a registered embedding that is the embedding included in the registration data, and thus specifies a fabric type that is the same as or similar to the target fabric; and a presentation unit that presents the print setting associated with the same or similar fabric type specified for the target fabric in the print setting data.

According to a second aspect of the present disclosure, a print setting presentation method of presenting a print setting in a printing device using a fabric as a print medium is provided. The print setting presentation method includes: for each of a plurality of fabric images acquired by picking up images of a plurality of fabrics, associating an embedding that represents a surface characteristic of the fabric and is a vector determined based on the fabric image, with a fabric type that is a type of the fabric represented by the fabric image, and thus preparing registration data; for each of a plurality of fabric types, preparing print setting data in which the fabric type and a print setting in the printing device are associated with each other; collating a target embedding that is the embedding based on a target fabric image acquired by picking up an image of a target fabric with a registered embedding that is the embedding included in the registration data, and thus specifying a fabric type that is the same as or similar to the target fabric; and presenting the print setting associated with the same or similar fabric type specified for the target fabric in the print setting data.

According to a third aspect of the present disclosure, a non-transitory computer-readable storage medium storing a program executed by a computer that presents a print setting in a printing device using fabric as a print medium is provided. The program causes the computer to implement: a function of preparing, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other; a function of preparing, for each of a plurality of fabric types, print setting data in which the fabric type and a print setting in the printing device are associated with each other; a function of collating a target embedding that is the embedding based on a target fabric image acquired by picking up an image of a target fabric with a registered embedding that is the embedding included in the registration data, and thus specifying a fabric type that is the same as or similar to the target fabric; and a function of presenting the print setting associated with the same or similar fabric type specified for the target fabric in the print setting data.

### BRIEF DESCRIPTION OF THE DRAWINGS

FIG. 1 illustrates a schematic configuration of a printing system according to an embodiment.

FIG. 2 illustrates an example of print setting data.

FIG. 3 illustrates the creation of split images.

FIG. 4 is a flowchart showing processing of registering registration data.

FIG. 5 illustrates an example of the registration data.

FIG. 6 is the first half of a flowchart showing processing for presenting print settings.

FIG. 7 is the second half of the flowchart showing the processing for presenting print settings.

FIG. 8 illustrates an example of collation data.

FIG. 9 illustrates an example of distance data.

### DESCRIPTION OF EMBODIMENTS

### A. Embodiment

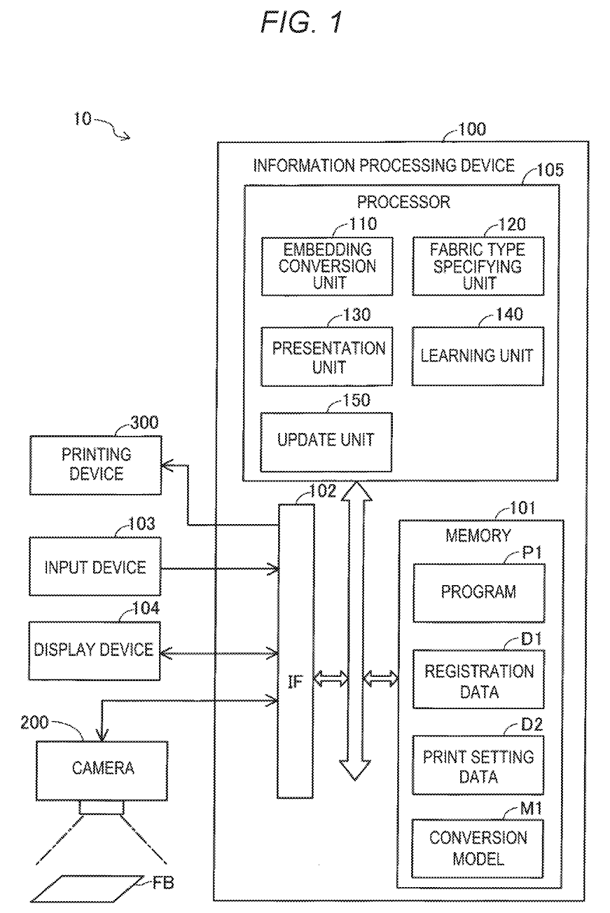

FIG. 1 illustrates a schematic configuration of a printing system 10 according to the present embodiment. The printing system 10 includes an information processing device 100, a camera 200, and a printing device 300. The printing device 300 is a textile printing machine that executes textile printing on a print medium made of fabric.

The information processing device 100 presents appropriate print settings for the printing device 300 that executes printing on the print medium made of fabric. The information processing device 100 is configured with, for example, a personal computer. The information processing device 100 includes a memory 101, an interface circuit 102, an input device 103 and a display device 104 coupled to the interface circuit 102, and a processor 105. The memory 101 stores programs and data used for various processing executed by the information processing device 100. In the illustrated example, a program P1, registration data D1, print setting data D2, and a conversion model M1 are stored in the memory 101. The registration data D1, the print setting data D2, and the conversion model M1 will be described later.

The camera 200 is used to pick up an image of the print medium. For example, the camera 200 picks up an image of a fabric FB, which is a print medium placed on a placement table, not illustrated, from directly above. The camera 200 outputs a fabric image acquired by picking up an image of the print medium, to the information processing device 100. The fabric image is an image acquired by picking up an image of a fabric serving as the print medium.

The information processing device 100 includes an embedding conversion unit 110, a fabric type specifying unit 120, a presentation unit 130, a learning unit 140, and an update unit 150. When the processor 105 executes the program P1 stored in the memory 101, the functions of these units are implemented.

The embedding conversion unit 110 converts the fabric image into an embedding, using the conversion model M1, described later. The embedding represents the surface characteristics of the fabric. The embedding is a vector of a numerical value converted from the fabric image.

The fabric type specifying unit 120 collates the embedding based on the target fabric image with the embedding included in the registration data D1 and thus specifies a fabric type that is the same as or similar to the target fabric. The "target fabric" is a fabric that is a target print medium for the presentation of print settings. The "target fabric image" is a fabric image acquired by picking up an image of the target fabric. Examples of the type of fabric include broad, satin, chiffon, and nylon taffeta.

The registration data D1 is data in which, for each of a plurality of fabric images acquired by picking up images of a plurality of fabrics, an embedding converted from the fabric image is associated with a fabric identification value for identifying a fabric type that is the type of fabric represented by the fabric image. The registration data D1 is created by the update unit 150. The memory 101 storing the registration data D1 is also referred to as a "registration data storage unit".

The presentation unit 130 presents the print setting associated with the fabric type specified by the fabric type specifying unit 120, in the print setting data D2.

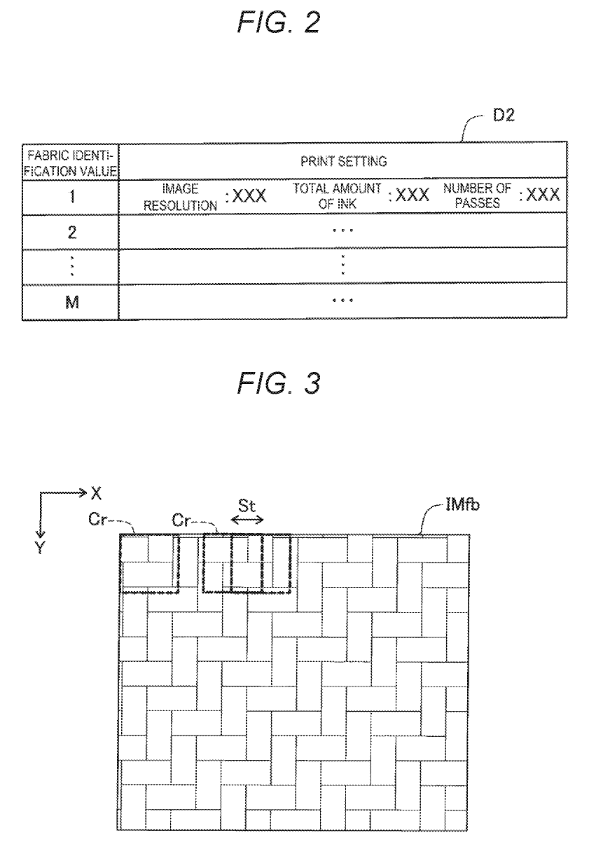

FIG. 2 illustrates an example of the print setting data D2. The print setting data D2 is data in which a fabric identification value indicating a fabric type and a print setting in the printing device 300 are associated with each other for each of M types of fabrics (M being a positive integer). The memory 101 storing the print setting data D2 is also referred to as a "print setting data storage unit". The print settings include settings such as the image resolution, the total amount of ink, and the number of passes. The number of passes indicates the number of times the head makes a reciprocating motion to print in a predetermined print range. The print setting data D2 is created in advance by the information processing device 100 or a device other than the information processing device 100.

The learning unit 140 executes machine learning and thus creates the conversion model M1 for converting a fabric image into an embedding.

The update unit 150 creates the registration data D1 in which the fabric identification value and the embedding converted from the fabric image are associated with each other for each of the plurality of fabric images. For example, the update unit 150 changes the content of a record included in the registration data D1 in response to an instruction from the user. For example, the update unit 150 adds a new record to the registration data D1 in response to an instruction from the user. For example, the update unit 150 deletes a part of a record included in the registration data D1 in response to an instruction of the user. The update unit 150 is also referred to as a "registration data creation unit".

In the present embodiment, a learning data set used for machine learning for creating the conversion model M1 is prepared as follows. For example, the learning unit 140 prepares the learning data set. The preparation of the learning data set includes the creation of split images. First, images of M types of fabrics (M being a positive integer) are picked up by the camera 200 and M fabric images are thus acquired. One of the M fabric images is divided into N pieces (N being a positive integer) and N split images are thus created.

FIG. 3 illustrates the creation of split images. FIG. 3 shows how an image IMfb is divided to create split images. The image IMfb is a picked-up image of the fabric. Here, an image of the fabric is picked up such that the image IMfb does not include the background of the fabric. A square selected region that is set in advance is selected from the image IMfb. The selected square region forms one split image Cr. In FIG. 3, the selected region representing the one split image Cr is indicated by a broken-line frame. The selected region is slid at each stride St that is set in advance. In the illustrated example, two selected regions continuous in the X-axis direction have parts overlapping each other. The illustrated example shows how the selected region is slid along the X-axis direction, but the selected region is sequentially slid along the X-axis direction and the Y-axis direction. Two selected regions continuous in the Y-axis direction may have parts overlapping each other. Alternatively, two selected regions continuous in the X-axis direction may not have parts overlapping each other. Two selected regions continuous in the Y-axis direction may not have parts overlapping each other.

Each of the N split images is associated with a fabric type, which is the type of fabric represented by the fabric image before division, as a label. The N split images created from the same fabric image are associated with the same fabric type as a label.

Also, each of the M fabric images is divided into N pieces. Each split image is associated with a fabric type as a label. In this way, M×N split images are prepared. A group of sets of split images and labels is used as a learning data set.

The machine learning executed by the learning unit 140 to create the conversion model M1 will now be described. As a first step, the learning unit 140 executes self-supervised learning. As a method of self-supervised learning, for example, SimSiam (Xinlei Chen, et al., "SimSiam: Exploring Simple Siamese Representation Learning", [online], [searched on Mar. 20, 2025], internet URL: https://doi.org/10.48550/arXiv.2011.10566) can be used. In the first step, learning is executed such that embeddings respectively converted from an augmented image acquired by performing data augmentation on a learning fabric image and a learning image are close to each other in an embedding space. The data augmentation includes rotating, flipping, cropping, color tone conversion, and the like. In the first step, since self-supervised learning is executed, the split images of the learning data set are used as input data, but the labels of the learning data set are not used. When two or more fabric images are input to a machine learning model created by the execution of self-supervised learning, the machine learning model outputs embeddings converted from the respective fabric images.

As a second step, the learning unit 140 executes transfer learning on the machine learning model created by executing self-supervised learning. In the present embodiment, the learning unit 140 executes deep metric learning in transfer learning. The learning unit 140 adjusts only the output layer in a state where layers other than the output layer of the machine learning model created by executing self-supervised learning are locked. The locking of the layers other than the output layer means that parameters are used as they are for the layers other than the output layer. As a method of deep metric learning, for example, FaceNet (Florian Schroff, et al., "FaceNet: A Unified Embedding for Face Recognition and Clustering", [online],[searched on Mar. 20, 2025], internet URL: https://doi.org/10.48550/arXiv.1503.03832) can be used. In the deep metric learning of the second step, learning is executed such that the fabric type indicated by the label of the learning data set is referred to, embeddings converted from two or more learning fabric images acquired by picking up images of the same fabric type are brought close to each other in the embedding space, and embeddings converted from two or more learning fabric images acquired by picking up images of different fabric types are moved away from each other in the embedding space. When the values of the labels associated with two or more learning fabric images are the same, the fabric types represented by the two or more learning fabric images are the same. When the values of the labels associated with two or more learning fabric images are different, the fabric types represented by the two or more learning fabric images are different. The conversion model M1 created by the execution of deep metric learning outputs embeddings converted from two or more learning fabric images.

In the present embodiment, since learning is executed without using a label in the self-supervised learning in the first step, efficient learning can be executed even when a large-scale learning data set is used.

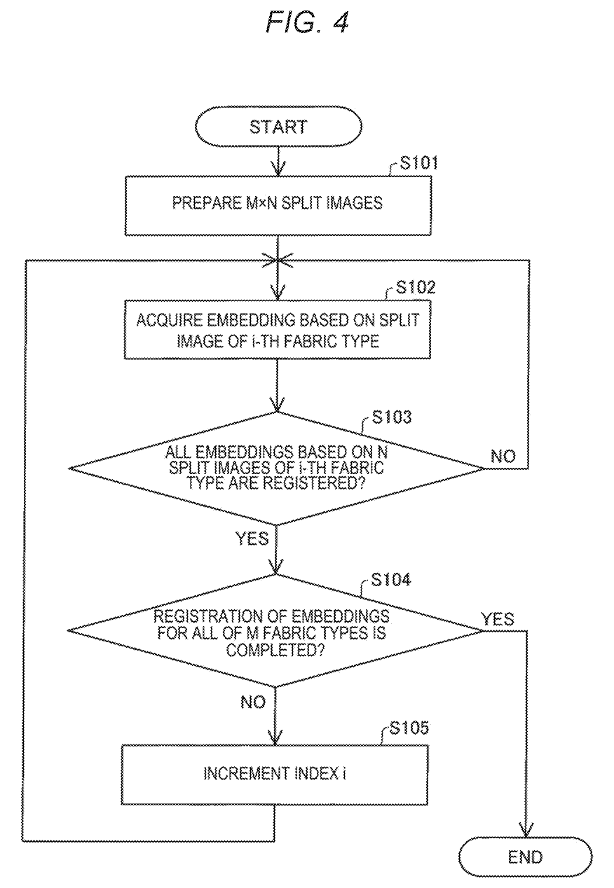

FIG. 4 is a flowchart showing processing of registering the registration data D1. At the start of the processing shown in FIG. 4, the conversion model M1 is generated by the above method.

In step S101, a plurality of split images are prepared. Here, M×N split images included in the learning data set are used.

In step S102, the embedding conversion unit 110 inputs one split image for an i-th fabric type (i being a positive integer and a value equal to or smaller than M) to the conversion model M1, and acquires an embedding output from the conversion model M1. The letter "i" represents an index for distinguishing the fabric type. The initial value of the index i is 1.

The embedding conversion unit 110 stores, in the memory 101, a record in which the fabric identification value, the image number for identifying the split image, and the acquired embedding are associated with each other. A group of records stored in the memory 101 in step S102 forms the registration data D1.

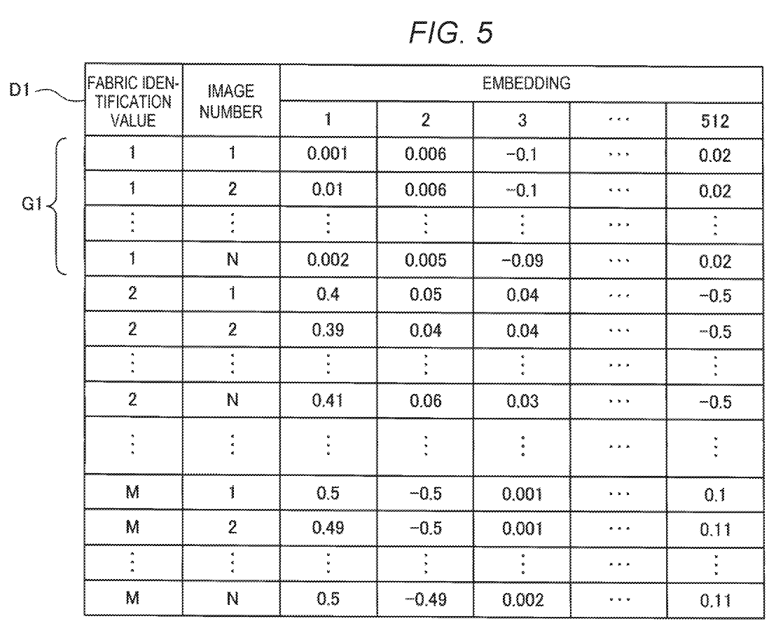

FIG. 5 illustrates an example of the registration data D1. The fabric identification value is a value indicating the type of the fabric represented by the split image that is input to the conversion model M1 and is the source from which the embedding is converted. The image number is a value for identifying the split image. In the illustrated example, serial numbers are assigned to a plurality of split images acquired by dividing the same fabric image. In the present embodiment, the embedding is expressed by a vector formed by arranging 512 numerical values. That is, the embedding is 512-dimensional data. In the illustrated example, each embedding included in a group G1 is converted from each of N split images acquired by dividing the same fabric image. The embedding included in the registration data D1 is also referred to as a "registered embedding".

As illustrated in FIG. 4, in step S103, the update unit 150 determines whether all the embeddings based on the N split images are registered for the i-th fabric type. When the update unit 150 determines that the embeddings based on all of the N split images are registered for the i-th fabric type (YES in step S103), the processing of step S104 is executed. Meanwhile, when the update unit 150 determines that all the embeddings based on the N split images are not registered for the i-th fabric type (NO in step S103), the processing of step S102 is executed again.

In step S104, the update unit 150 determines whether the processing of registering the embedding is completed for all of the M fabric types. When the update unit 150 determines that the processing of registering the embedding is not completed for all the M fabric types (NO in step S104), the processing of step S105 is executed. When the update unit 150 determines that the processing of registering the embedding is completed for all of the M fabric types (YES in step S104), the processing shown in FIG. 4 ends.

In step S105, the update unit 150 increments the index i. Subsequently, the processing of step S102 is executed again.

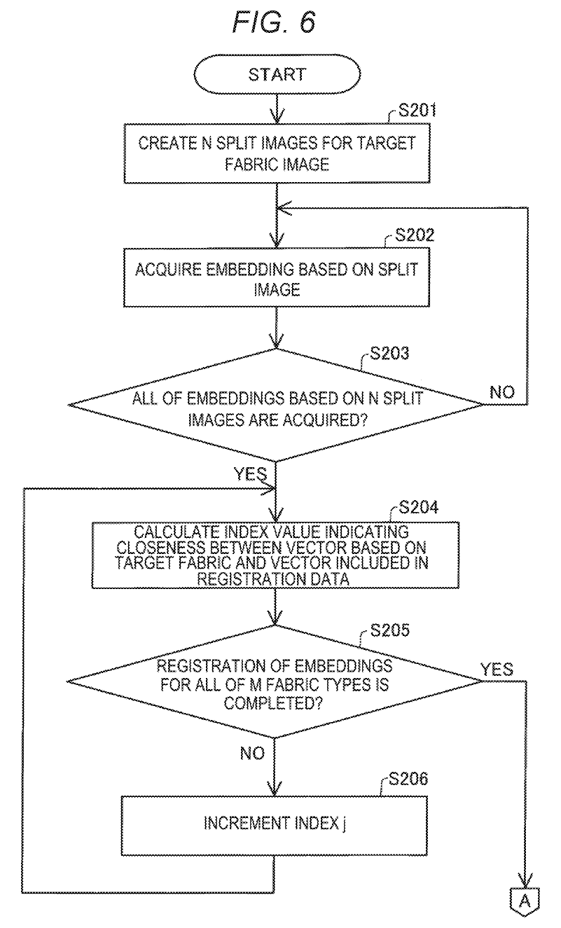

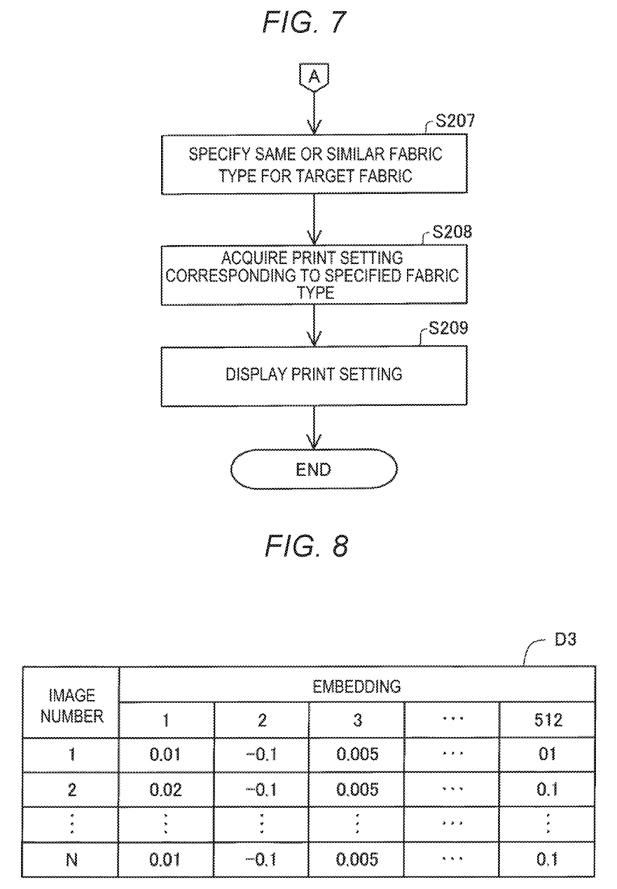

FIGS. 6 and 7 are flowcharts showing processing for specifying the fabric type of the target fabric and presenting the print setting. At the start of the processing shown in FIG. 6, the registration processing of the registration data D1 (see FIG. 4) is complete. That is, the registration data D1 is registered.

In step S201, the fabric type specifying unit 120 creates N split images for the target fabric image. First, the fabric type specifying unit 120 controls the camera 200 to execute the image pickup of the target fabric and acquires the target fabric image. It is assumed that the background of the fabric is not included in the target fabric image. The fabric type specifying unit 120 divides the target fabric image into N pieces and thus creates N split images. The method of dividing the fabric image is the same as in the preparation of the learning data set (see FIG. 3).

In step S202, the embedding conversion unit 110 inputs one split image among the N split images to the conversion model M1 and acquires the embedding output from the conversion model M1. In the present embodiment, an embedding that is a vector formed by arranging 512 numerical values is acquired, based on one split image. The embedding based on the input split image is also referred to as a "target embedding".

FIG. 8 illustrates an example of collation data D3.

The embedding conversion unit 110 stores, in the memory 101, a record in which the image number for identifying the split image and the acquired embedding are associated with each other. In step S202, a group of records stored in the memory 101 forms the collation data D3. Since the collation data D3 is temporarily created in the print setting presentation processing, the collation data D3 is not illustrated in FIG. 1.

As illustrated in FIG. 6, in step S203, the fabric type specifying unit 120 determines whether all the embeddings based on the N split images are acquired. When the fabric type specifying unit 120 determines that the embeddings are acquired for all of the N split images (YES in step S203), the processing of step S204 is executed. Meanwhile, when the fabric type specifying unit 120 determines that all the embeddings based on each of the N split images are not acquired (NO in step S203), the processing of step S202 is executed again.

In step S204, the fabric type specifying unit 120 calculates an index value indicating the closeness between N vectors based on the target fabric included in the collation data D3 and N vectors associated with the j-th fabric included in the registration data D1. The letter "j" represents an index for distinguishing the fabric type. In the present embodiment, the index j coincides with the fabric identification value. The index j is a positive integer and a value equal to or smaller than M. The initial value of the index j is 1.

As the index value representing the closeness between the two vectors, for example, the Euclidean distance or cosine similarity can be used. The Euclidean distance can be calculated by taking the square root of the sum of values found by squaring the difference between the components of the two vectors. The cosine similarity can be calculated by dividing the inner product of two vectors by the product of the Euclidean norms of the respective vectors. Here, an example in which the Euclidean distance is used as the index value representing the closeness between two vectors will be described.

When the fabric type specifying unit 120 calculates the Euclidean distance between each of the N vectors included in the collation data D3 and each of the N vectors of one fabric type included in the registration data D1, N² Euclidean distances are found. The distance between the two vectors becomes shorter as the value of the Euclidean distance becomes smaller. The fabric type specifying unit 120 selects N²/2 Euclidean distances in ascending order of value, from among the N² Euclidean distances. The fabric type specifying unit 120 calculates the average value of the selected N²/2 Euclidean distances. In the present embodiment, the calculated average value is the distance between the embedding of the target fabric and the embedding of one fabric identification value included in the registration data D1.

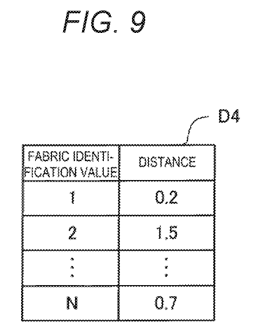

FIG. 9 illustrates an example of distance data D4 indicating the distance between the embedding of the target fabric and the embedding included in the registration data D1. The fabric type specifying unit 120 stores, in the memory 101, a record in which the fabric identification value and the calculated average value are associated with each other. A group of records stored in the memory 101 forms the distance data D4. Since the distance data D4 is temporarily created in the print setting presentation process, the distance data D4 is not illustrated in FIG. 1.

As illustrated in FIG. 6, in step S205, the fabric type specifying unit 120 determines whether the distance between the embedding of the target fabric and the embedding included in the registration data D1 is calculated for all of the M fabric types. When the fabric type specifying unit 120 determines that the distance between the embedding of the target fabric and the embedding included in the registration data D1 is not calculated for all of the M fabric types (NO in step S205), the processing of step S206 is executed. When the fabric type specifying unit 120 determines that the distance between the embedding of the target fabric and the embedding included in the registration data D1 is calculated for all of the M fabric types (YES in step S205), the processing of step S207 is executed.

In step S206, the fabric type specifying unit 120 increments the index j. Subsequently, the processing of step S204 is executed again.

As illustrated in FIG. 7, in step S207, the fabric type specifying unit 120 identifies a fabric type that is the same as or similar to the fabric type of the target fabric. First, the fabric type specifying unit 120 specifies a value less than a preset first threshold value among the distances included in the distance data D4 (see FIG. 9). When a plurality of values less than the first threshold value are included in the distances included in the distance data D4, the fabric type specifying unit 120 selects the minimum value among the plurality of values. The fabric type specifying unit 120 identifies a fabric identification value associated with the distance less than the first threshold in the distance data D4. The fabric type specifying unit 120 determines that the fabric type indicating the specified fabric identification value is the same as the fabric type of the target fabric. Note that being the same as the fabric type of the target fabric includes not only a case of being exactly the same as the fabric type of the target fabric but also a case of being regarded as being the same as the fabric type of the target fabric without substantially any difference from the fabric type of the target fabric. When there is no value less than the first threshold value among the distances included in the distance data D4, the fabric type specifying unit 120 specifies a value less than a preset second threshold value among the distances included in the distance data D4. The second threshold is set to a value exceeding the first threshold. The fabric type specifying unit 120 specifies a fabric identification value associated with the distance less than the second threshold in the distance data D4. The fabric type specifying unit 120 determines that the fabric type indicating the specified fabric identification value is similar to the fabric type of the target fabric.

In step S208, the presentation unit 130 acquires the print setting associated with the same or similar fabric type specified in step S207 from the print setting data D2 (see FIG. 2).

In step S209, the presentation unit 130 outputs an image representing the print settings to the display device 104. The display device 104 displays an image (not shown) representing print settings.

As described above, in the present embodiment, the embedding based on the target fabric image is collated with the embedding included in the registration data, and the fabric type that is the same as or similar to the target fabric is thus specified. Moreover, the print settings associated with the specified fabric type are presented. In textile printing, even when the same image is printed, a print setting such as the amount of ink ejection may need to be changed according to the type of fabric of the print medium. When a fabric is used as the print medium, as compared with a print medium formed of paper, the cost tends to increase as the number of times of redoing printing increases. In the present embodiment, since appropriate candidates for the print setting according to the fabric type are presented, the user can easily select the print setting for printing using the target fabric as the print medium. Thus, an increase in cost due to an increase of redoing of printing can be suppressed.

### B. Other Embodiments

(B1) In the above-described embodiment, in order to specify the same fabric type as the fabric type of the target fabric, the fabric type specifying unit 120 first specifies a value less than the first threshold among the distances included in the distance data D4. When there is no distance less than the first threshold value in the distance data D4, the fabric type specifying unit 120 specifies a value less than the second threshold value among the distances included in the distance data D4 (see step S207 in FIG. 7).

Alternatively, the fabric type specifying unit 120 may specify a value less than the second threshold among the distances included in the distance data D4 regardless of whether there is a distance less than the first threshold in the distance data D4.

(B2) When the fabric type specifying unit 120 specifies a plurality of fabric types as the same or similar fabric type for the target fabric, the presentation unit 130 may present the print setting corresponding to each of the plurality of specified fabric types. The user can select desired print setting from among suitable print settings at the time of printing using the target fabric, which is the print medium.

Alternatively, when the fabric type specifying unit 120 specifies a plurality of fabric types as the same or similar fabric type for the target fabric, print settings corresponding to a predetermined number of fabric types may be presented in order of closeness to the target fabric among the plurality of specified fabric types. The user can select a desired print setting from more suitable print settings at the time of printing using the target fabric, which is the print medium.

The presentation unit 130 may present a representative fabric image representing the specified same or similar fabric type together with the print setting associated with the same or similar fabric type specified for the target fabric. As the representative fabric image, for example, one split image Cr among the N split images Cr used at the time of creating the registration data D1 is used. In this case, for example, a fabric image table in which the fabric identification value and the saving destination address of the split image Cr as the representative fabric image are associated with each other is stored in the memory 101 in advance. The representative fabric image is stored in the memory 101 in advance. The presentation unit 130 specifies the saving destination address of the representative fabric image with reference to the fabric image table, based on the fabric identification value of the same or similar fabric type specified for the target fabric. The presentation unit 130 outputs the print setting including the representative fabric image saved at the specified saving destination address, to the display device 104.

(B3) In the above-described embodiment, an example in which the information processing device 100 specifies a fabric type that is the same as or similar to the target fabric, and presents the print setting associated with the specified same or similar fabric type, is described. The present disclosure is applicable not only to a scene where print settings are presented but also to a scene where settings for preprocessing and settings for drying are presented.

There are fabrics with similar patterns shown on the front surface and the back surface, such as a scarf. When such a printed object is created by textile printing, preprocessing in which a penetrant that induces the permeation of the ink permeates the fabric may be executed before textile printing is executed. The settings for preprocessing include, for example, settings of the type of the penetrant, the concentration of the penetrant, and the penetration time. When the settings for preprocessing are presented according to the fabric type, data in which the fabric identification value indicating the fabric type and the settings for preprocessing are associated with each other for each of a plurality of fabric types is prepared in advance. The information processing device 100 can specify a fabric type that is the same as or similar to the target fabric and present settings for preprocessing associated with the specified same or similar fabric type. Since the candidates for the appropriate setting for preprocessing are presented according to the fabric type of the print medium, the user can easily select the setting for preprocessing.

Drying is to dry the print medium with a dryer after textile printing. The settings for drying include settings of temperature and drying time. When the settings for drying are presented according to the fabric type, data in which the fabric identification value indicating the fabric type and the settings for drying are associated with each other is prepared in advance for each of a plurality of fabric types. The information processing device 100 can specify a fabric type that is the same as or similar to the target fabric, and present settings for drying associated with the specified same or similar fabric type. Since the candidates for the appropriate setting for drying according to the fabric type are presented, the user can easily select the setting for drying.

(B4) In the above embodiment, an example in which Sim Siam is used as the method of self-supervised learning in the first step in order to create the conversion model M1 is described. Alternatively, any of the following methods may be adopted as a method of self-supervised learning.

SimCLR (Ting Chen, et al., "SimCLR: A Simple Framework for Contrastive Learning of Visual Representations", [online], [searched on Mar. 20, 2025], internet URL: https://doi.org/10.48550/arXiv.2002.05709), and BYOL (Jean-Bastien Grill, et al., "BYOL: Bootstrap your own latent", [online], [searched on Mar. 20, 2025], internet URL: https://doi.org/10.48550/arXiv.2006.07733)

SwAV: Swapping Assignments between Views (Mathilde Caron, et al., "Unsupervised Learning of Visual Features by Contrasting Cluster Assignments", [online], [searched on Mar. 20, 2025], internet URL: https://doi.org/10.48550/arXiv.2006.09882)

In the above embodiment, an example in which FaceNet is used as a method of deep metric learning in the second step in order to create the conversion model M1 is described. Alternatively, any one of the following methods may be adopted as a deep metric learning method.

CosFace (Hao Wang, et al., "CosFace: Large Margin Cosine Loss for Deep Face Recognition", [online], [searched on Mar. 20, 2025], internet URL: https://doi.org/10.48550/arXiv.1801.09414)

ArcFace (Jiankang Deng, et al., "ArcFace: Additive Angular Margin Loss for Deep Face Recognition", [online], [searched on Mar. 20, 2025], internet URL: https://doi.org/10.48550/arXiv.1801.07698)

In the above embodiment, an example in which self-supervised learning in the first step and deep metric learning as transfer learning in the second step are executed in order to create the conversion model M1 is described. Alternatively, the conversion model M1 may be created by executing only deep metric learning. In deep metric learning, learning is executed in which embeddings converted from two or more learning fabric images acquired by picking up images of the same fabric type are brought close to each other in an embedding space, and embeddings converted from two or more learning fabric images acquired by picking up images of different fabric types are moved away from each other in the embedding space.

The present disclosure is not limited to the above-described embodiments and can be implemented with various configurations without departing from the spirit and scope of the present disclosure. For example, technical features in the embodiments corresponding to technical features in the aspects described in the summary of the disclosure can be replaced or combined as appropriate to solve a part or all of the problems described above or to achieve a part or all of the effects described above. Also, any of the technical features can be deleted as appropriate unless described as essential in the present specification.

### C. Other Aspects

(1) According to a first aspect of the present disclosure, an information processing device that presents a print setting in a printing device using a fabric as a print medium is provided. The information processing device includes: a registration data storage unit that stores, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other; a print setting data storage unit that stores, for each of a plurality of fabric types, print setting data in which the fabric type and a print setting in the printing device are associated with each other; a fabric type specifying unit that collates a target embedding that is the embedding based on a target fabric image acquired by picking up an image of a target fabric with a registered embedding that is the embedding included in the registration data, and thus specifies a fabric type that is the same as or similar to the target fabric; and a presentation unit that presents the print setting associated with the same or similar fabric type specified for the target fabric in the print setting data.

According to the above aspect, since the print setting associated with the fabric type that is the same as or similar to the target fabric that is the print medium is presented, the user can easily select the print setting at the time of printing using the target fabric as the print medium.

(2) In the information processing device according to the above aspect, in the collation, the fabric type specifying unit may specify the same or similar fabric type for the target fabric, based on closeness between the target embedding and the registered embedding in an embedding space of the embedding.

(3) In the information processing device according to the above aspect, the fabric type specifying unit may specify that the fabric type associated with the registered embedding for which an index value indicating the closeness between the target embedding and the registered embedding is less than a predetermined first threshold value is a fabric type that is the same as the target fabric.

(4) In the information processing device according to the above aspect, the fabric type specifying unit may specify that the fabric type associated with the registered embedding for which the index value is less than a predetermined second threshold value as a value exceeding the first threshold value is a fabric type similar to the target fabric.

(5) In the information processing device according to the above aspect, when the fabric type specifying unit specifies a plurality of the same or similar fabric types for the target fabric, the presentation unit may present the print setting corresponding to each of the plurality of the same or similar fabric types specified for the target fabric.

The user can select a desired print setting from the plurality of suitable print settings that are presented.

(6) The information processing device according to the aspect further includes an embedding conversion unit that converts the target fabric image into the embedding, using a machine learning model. The machine learning model may be generated by executing deep metric learning in which the embeddings converted from two or more learning fabric images acquired by picking up images of the same fabric type are brought close to each other in the embedding space, and the embeddings converted from two or more learning fabric images acquired by picking up images of different fabric types are moved away from each other in the embedding space.

(7) The information processing device according to the above aspect may further include a registration data creation unit that divides, for each of a plurality of fabrics of different fabric types, an image formed by picking up an image of the fabric into N pieces (N being a positive integer) and thus acquires the plurality of fabric images, and associates, for each of the plurality of fabric images, the embedding converted by the embedding conversion unit with the fabric type and thus creates the registration data.

(8) In the information processing device according to the above aspect, the presentation unit may present the print setting associated with the same or similar fabric type specified for the target fabric and a representative fabric image representing the specified same or similar fabric type.

(9) According to a second aspect of the present disclosure, a print setting presentation method of presenting a print setting in a printing device using a fabric as a print medium is provided. The print setting presentation method includes: for each of a plurality of fabric images acquired by picking up images of a plurality of fabrics, associating an embedding that represents a surface characteristic of the fabric and is a vector determined based on the fabric image, with a fabric type that is a type of the fabric represented by the fabric image, and thus preparing registration data; for each of a plurality of fabric types, preparing print setting data in which the fabric type and a print setting in the printing device are associated with each other; collating a target embedding that is the embedding based on a target fabric image acquired by picking up an image of a target fabric with a registered embedding that is the embedding included in the registration data, and thus specifying a fabric type that is the same as or similar to the target fabric; and presenting the print setting associated with the same or similar fabric type specified for the target fabric in the print setting data.

(10) According to a third aspect of the present disclosure, a non-transitory computer-readable storage medium storing a program executed by a computer that presents a print setting in a printing device using fabric as a print medium is provided. The program causes the computer to implement: a function of preparing, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other; a function of preparing, for each of a plurality of fabric types, print setting data in which the fabric type and a print setting in the printing device are associated with each other; a function of collating a target embedding that is the embedding based on a target fabric image acquired by picking up an image of a target fabric with a registered embedding that is the embedding included in the registration data, and thus specifying a fabric type that is the same as or similar to the target fabric; and a function of presenting the print setting associated with the same or similar fabric type specified for the target fabric in the print setting data.

What is claimed is:

1. An information processing device that presents a print setting in a printing device using a fabric as a print medium, the information processing device comprising:
a registration data storage unit configured to store, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other;
a print setting data storage unit configured to store, for each of a plurality of fabric types, print setting data in which the fabric type and a print setting in the printing device are associated with each other;
a fabric type specifying unit configured to collate a target embedding that is the embedding based on a target fabric image acquired by picking up an image of a target fabric with a registered embedding that is the embedding included in the registration data, and thus specify a fabric type that is the same as or similar to the target fabric; and
a presentation unit configured to present the print setting associated with the same or similar fabric type specified for the target fabric in the print setting data.

2. The information processing device according to claim 1, wherein
the fabric type specifying unit,
in the collation, specifies the same or similar fabric type for the target fabric, based on closeness between the target embedding and the registered embedding in an embedding space of the embedding.

3. The information processing device according to claim 2, wherein
the fabric type specifying unit
specifies that the fabric type associated with the registered embedding for which an index value indicating the closeness between the target embedding and the registered embedding is less than a predetermined first threshold value is a fabric type that is the same as the target fabric.

4. The information processing device according to claim 3, wherein
the fabric type specifying unit
specifies that the fabric type associated with the registered embedding for which the index value is less than a predetermined second threshold value as a value exceeding the first threshold value is a fabric type similar to the target fabric.

5. The information processing device according to claim 4, wherein
when the fabric type specifying unit specifies a plurality of the same or similar fabric types for the target fabric,
the presentation unit presents the print setting corresponding to each of the plurality of the same or similar fabric types specified for the target fabric.

6. The information processing device according to claim 5, further comprising:
an embedding conversion unit configured to convert the target fabric image into the embedding, using a machine learning model, wherein
the machine learning model
is generated by executing deep metric learning in which the embeddings converted from two or more learning fabric images acquired by picking up images of the same fabric type are brought close to each other in the embedding space, and the embeddings converted from two or more learning fabric images acquired by picking up images of different fabric types are moved away from each other in the embedding space.

7. The information processing device according to claim 6, further comprising:
a registration data creation unit configured to
divide, for each of a plurality of fabrics of different fabric types, an image formed by picking up an image of the fabric into N pieces (N being a positive integer) and thus acquire the plurality of fabric images, and
associate, for each of the plurality of fabric images, the embedding converted by the embedding conversion unit with the fabric type and thus create the registration data.

8. The information processing device according to claim 1, wherein
the presentation unit presents the print setting associated with the same or similar fabric type specified for the target fabric and a representative fabric image representing the specified same or similar fabric type.

9. A print setting presentation method of presenting a print setting in a printing device using a fabric as a print medium, the print setting presentation method comprising:
for each of a plurality of fabric images acquired by picking up images of a plurality of fabrics, associating an embedding that represents a surface characteristic of the fabric and is a vector determined based on the fabric image, with a fabric type that is a type of the fabric represented by the fabric image, and thus preparing registration data;
for each of a plurality of fabric types, preparing print setting data in which the fabric type and a print setting in the printing device are associated with each other;
collating a target embedding that is the embedding based on a target fabric image acquired by picking up an image of a target fabric with a registered embedding that is the embedding included in the registration data, and thus specifying a fabric type that is the same as or similar to the target fabric; and
presenting the print setting associated with the same or similar fabric type specified for the target fabric in the print setting data.

10. A non-transitory computer-readable storage medium storing a program executed by a computer that presents a print setting in a printing device using fabric as a print medium, the program causing the computer to implement:
a function of preparing, for each of a plurality of fabric images acquired by picking up images of a plurality of fabrics, registration data in which an embedding that represents a surface characteristic of the fabric and is a vector determined based on the fabric image and a fabric type that is a type of the fabric represented by the fabric image are associated with each other;
a function of preparing, for each of a plurality of fabric types, print setting data in which the fabric type and a print setting in the printing device are associated with each other;
a function of collating a target embedding that is the embedding based on a target fabric image acquired by picking up an image of a target fabric with a registered embedding that is the embedding included in the registration data, and thus specifying a fabric type that is the same as or similar to the target fabric; and
a function of presenting the print setting associated with the same or similar fabric type specified for the target fabric in the print setting data.
